(19) United States
(12) Patent Application Publication
(10) Pub. No.: US 2021/0124992 A1
(43) Pub. Date: Apr. 29, 2021

(54) METHOD AND APPARATUS FOR GENERATING INTEGRATED FEATURE VECTOR

(71) Applicant: SAMSUNG SDS CO., LTD., Seoul (KR)

(72) Inventors: Sun-Jin Kim, Seoul (KR); Min-Kyu Kim, Seoul (KR); Do-Young Park, Seoul (KR); Reddy Yarram Naresh, Seoul (KR)

(21) Appl. No.: 16/665,700

(22) Filed: Oct. 28, 2019

(30) Foreign Application Priority Data
Oct. 23, 2019 (KR) 10-2019-0132449

(51) Int. Cl. G06K 9/62; G06K 9/46

(52) U.S. Cl. CPC G06K 9/6255; G06K 9/627; G06K 9/6256; G06K 9/46

(57) ABSTRACT

A method of generating an integrated feature vector according to an embodiment is a method performed in a computing device including one or more processors and a memory for storing one or more programs executed by the one or more processors. The method includes receiving a plurality of images of an object; and generating the integrated feature vector including a feature vector of each of the plurality of images, wherein the plurality of images is generated in a plurality of environments different from each other.

### TECHNICAL FIELD

Embodiments of present invention relate to a technique of generating a feature vector for classifying an object from a plurality of images of the object.

### BACKGROUND ART

Detecting a defect of a product before the product is delivered to a consumer is one of the main objects of all manufacturing industries. In the manufacturing industry, the possibility of classifying a defect of a product is enhanced by applying various methods, from a computer vision algorithm of a traditional method to artificial intelligence (AI) based on deep learning, to detect the defect.

The conventionally used classification models based on deep learning learn the class of each image by using one sheet of training image data at a time and predict a class of an image data of a real product by using model weights acquired through the learning. By the nature of the manufacturing industry, to detect a defect and a fault of a product, a plurality 20 of images of the product is generated while changing a light source from a bright lighting environment to a dark lighting environment, or a plurality of images of the product is generated while changing the position or the angle of a camera photographing the product. Since the existing classification models assume a universal environment without considering the characteristics of the manufacturing industry, the relation among the image data generated in various environments is not considered.

Therefore, the existing classification models have a limitation in that they cannot normally classify a plurality of images obtained in the various environments described above. Accordingly, the existing classification models have a problem of showing a different classification result for each image generated in various environments for the same object.

### DISCLOSURE

### Technical Problem

Embodiments of the present invention are to provide a method and an apparatus for generating an integrated feature vector.

### Technical Solution

In one general aspect, there is provided a method of generating an integrated feature vector performed in a computing device including one or more processors and a memory for storing one or more programs executed by the one or more processors, the method comprising: receiving a plurality of images of an object; and generating the integrated feature vector including a feature vector of each of the plurality of images, wherein the plurality of images is generated in a plurality of environments different from each other.

The plurality of environments may include at least one or more among an environment in which a plurality of light sources is installed and an environment in which the object is photographed from a plurality of positions.

The generating may include: extracting the feature vector of each of the plurality of images; generating at least one among an average feature vector, a minimum feature vector and a maximum feature vector on the basis of the feature vector of each of the plurality of images; and generating the integrated feature vector including at least one among the average feature vector, the minimum feature vector and the maximum feature vector, and the feature vector of each of the plurality of images.

The extracting may include extracting the feature vector of each of the plurality of images by using a plurality of feature extraction models trained on the basis of a plurality of training images photographed in one of the plurality of photographing environments.

The plurality of feature extraction models may be independently trained by using initial parameters independent from each other.

The plurality of feature extraction models may be sequentially trained by using a parameter of a previously trained feature extraction model among the plurality of feature extraction models as an initial parameter of a feature extraction model to be trained currently among the plurality of feature extraction models.

The average feature vector may include an average value of feature values at a same location in the feature vector of each of the plurality of images.

The minimum feature vector may include a feature value having a minimum value among feature values at a same location in the feature vector of each of the plurality of images.

The maximum feature vector may include a feature value having a maximum value among feature values at a same location in the feature vector of each of the plurality of images.

The method of generating an integrated feature vector may further comprise classifying the object on the basis of the integrated feature vector.

In another general aspect, there is provided an apparatus for generating an integrated feature vector comprises one or more processors, a memory, and one or more programs, wherein the one or more programs are stored in the memory and configured to be executed by the one or more processors and include commands for executing: receiving a plurality of images of an object; and generating the integrated feature vector including a feature vector of each of the plurality of images, wherein the plurality of images is generated in a plurality of environments different from each other.

The plurality of environments may include at least one or more among an environment in which a plurality of light sources is installed and an environment in which the object is photographed from a plurality of positions.

The generating includes: extracting the feature vector of each of the plurality of images; generating at least one among an average feature vector, a minimum feature vector and a maximum feature vector on the basis of the feature vector of each of the plurality of images; and generating the integrated feature vector including at least one among the average feature vector, the minimum feature vector and the maximum feature vector, and the feature vector of each of the plurality of images.

The extracting may include extracting the feature vector of each of the plurality of is images by using a plurality of feature extraction models trained on the basis of a plurality of training images photographed in one of the plurality of photographing environments.

The plurality of feature extraction models may be independently trained by using initial parameters independent from each other.

The plurality of feature extraction models may be sequentially trained by using a parameter of a previously trained feature extraction model among the plurality of feature extraction models as an initial parameter of a feature extraction model to be trained currently among the plurality of feature extraction models.

The average feature vector may include an average value of feature values at a same location in the feature vector of each of the plurality of images.

The minimum feature vector may include a feature value having a minimum value among feature values at a same location in the feature vector of each of the plurality of images.

The maximum feature vector may include a feature value having a maximum value among feature values at a same location in the feature vector of each of the plurality of images.

The one or more programs may further include commands for executing classifying the object on the basis of the integrated feature vector.

### Effects of the Invention

According to the disclosed embodiments, as an integrated feature vector is generated from a plurality of images generated by photographing an object in a plurality of different photographing environments, a plurality of images of the object is inputted into a model as one piece of data, and thus the accuracy of object classification of the model can be enhanced.

In addition, the problem of the convention technique which cannot classify an image generated in a photographing environment of extreme brightness, such as a very dark or bright photographing environment, can be solved, and the time consumed for processing an image that is difficult to classify can be reduced.

### BRIEF DESCRIPTION OF THE DRAWINGS

FIG. 1 is a block diagram showing an example of a computing environment including a computing device appropriate to be used in exemplary embodiments.

FIG. 2 is a flowchart illustrating a method of generating an integrated feature vector according to an embodiment.

FIG. 3 is a view showing an example of a plurality of images generated in a plurality of environments different from each other according to an embodiment.

FIG. 4 is a view showing another example of a plurality of images generated in a plurality of environments different from each other according to an embodiment.

FIG. 5 is a view showing an example of classifying an object on the basis of an integrated feature vector according to an embodiment.

### DETAILED DESCRIPTION

Hereafter, specific embodiments of the present invention will be described with reference to the accompanying drawings. The detailed description is provided below to help comprehensive understanding of the methods, apparatuses and/or systems described in this specification. However, these are only an example, and the present invention is not limited thereto.

In describing the embodiments of the present invention, when it is determined that specific description of known techniques related to the present invention unnecessarily blurs the gist of the present invention, the detailed description will be omitted. In addition, the terms described below are terms defined considering the functions of the present invention, and these may vary according to user, operator's intention, custom or the like. Therefore, definitions thereof should be determined on the basis of the full text of the specification. The terms used in the detailed description are only for describing the embodiments of the present invention and should not be restrictive. Unless clearly used otherwise, expressions of singular forms include meanings of plural forms. In the description, expressions such as “include”, “provide” and the like are for indicating certain features, numerals, steps, operations, components, some of these, or a combination thereof, and they should not be interpreted to preclude the presence or possibility of one or more other features, numerals, steps, operations, components, some of these, or a combination thereof, in addition to those described above.

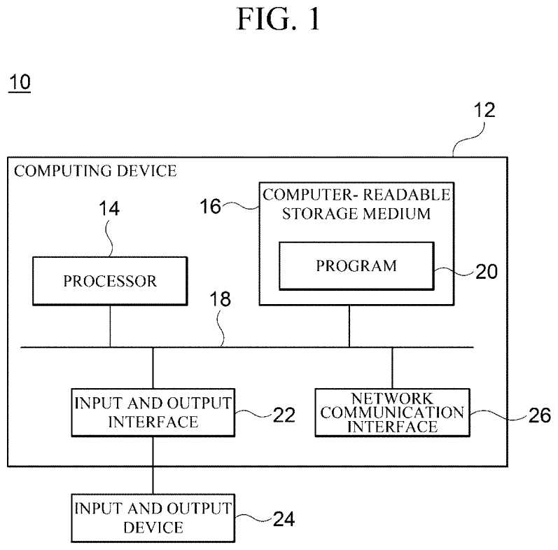

FIG. 1 is a block diagram showing an example of a computing environment 10 including a computing device appropriate to be used in exemplary embodiments. In the embodiment shown in the figure, each of the components may have a different function and ability in addition to those described below, and additional components other than those described below may be included.

The computing environment 10 shown in the figure includes a computing device 12. In an embodiment, the computing device 12 may be an apparatus for generating an integrated feature vector according to the embodiments.

The computing device 12 includes at least a processor 14, a computer-readable storage medium 16, and a communication bus 18. The processor 14 may direct the computing device 12 to operate according to the exemplary embodiments described above. For example, the processor 14 may execute one or more programs stored in the computer-readable storage medium 16. The one or more programs may include one or more computer executable commands, and the computer executable commands may be configured to direct the computing device 12 to perform operations according to the exemplary embodiment when the commands are executed by the processor 14.

The computer-readable storage medium 16 is configured to store computer-executable commands and program codes, program data and/or information of other appropriate forms. The programs 20 stored in the computer-readable storage medium 16 include a set of commands that can be executed by the processor 14. In an embodiment, the computer-readable storage medium 16 may be memory (volatile memory such as random access memory, non-volatile memory, or an appropriate combination of these), one or more magnetic disk storage devices, optical disk storage devices, flash memory devices, other forms of storage media that can be accessed by the computing device 12 and is capable of storing desired information, or an appropriate combination of these.

The communication bus 18 interconnects various different components of the computing device 12, including the processor 14 and the computer-readable storage medium 16.

The computing device 12 may also include one or more input and output interfaces 22 and one or more network communication interfaces 26, which provide an interface for one or more input and output devices 24. The input and output interfaces 22 and the network communication interfaces 26 are connected to the communication bus 18. The input and output devices 24 may be connected to other components of the computing device 12 through the input and output interfaces 22. Exemplary input and output devices 24 may include input devices such as a pointing device (a mouse, a track pad, etc.), a keyboard, a touch input device (a touch pad, a touch screen, etc.), a voice or sound input device, various kinds of sensor devices and/or photographing devices, and/or output devices such as a display device, a printer, a speaker and/or a network card. The exemplary input and output devices 24 may be included inside the computing device 12 as a component configuring the computing device 12 or may be connected to the computing device 12 as a separate apparatus distinguished from the computing device 12.

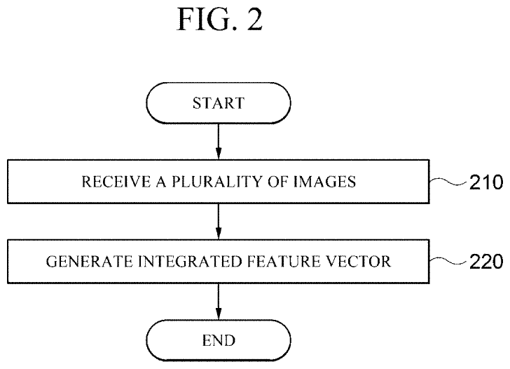

FIG. 2 is a flowchart illustrating a method of generating an integrated feature vector according to an embodiment.

The method shown in FIG. 2 may be executed by the computing device 12 provided with, for example, one or more processors and a memory for storing one or more programs executed by the one or more processors. Although the method is described as being divided into a plurality of operations in the flowchart shown in the figure, at least some of the operations may be performed in a different order or in combination and together with the other operations, omitted, divided into detailed operations, or performed in accompany with one or more operations not shown in the figure.

Referring to FIG. 2, at step 210, the computing device 12 receives a plurality of images of an object.

In an embodiment, the plurality of images may be generated in a plurality of environments different from each other. At this point, the plurality of environments may include various environments for generating a plurality of images of an object. For example, the plurality of environments may include various environments for generating a plurality of images of an object, such as an environment in which a plurality of light sources each having different brightness is installed, an environment in which an object is photographed from a plurality of different locations using one camera, and an environment in which a plurality of cameras is installed at different locations. At this point, the plurality of images of an object generated in a plurality of environments may include images generated in a plurality of environments in which conditions such as luminance, the number of light sources, brightness of the light sources, location of a camera, angle of a camera, the number of cameras and the like are diversely set.

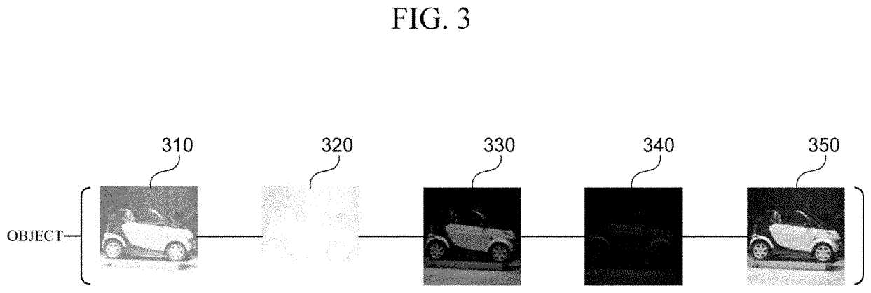

For example, as shown in FIG. 3, the plurality of environments may be an environment in which a plurality of light sources is installed. Referring to FIG. 3, a plurality of images 310, 320, 330, 340, 350 of an object may be images generated in different brightness. Accordingly, the plurality of images 310, 320, 330, 340, 350 of an object may include images generated in diverse brightness, from bright images to dark images.

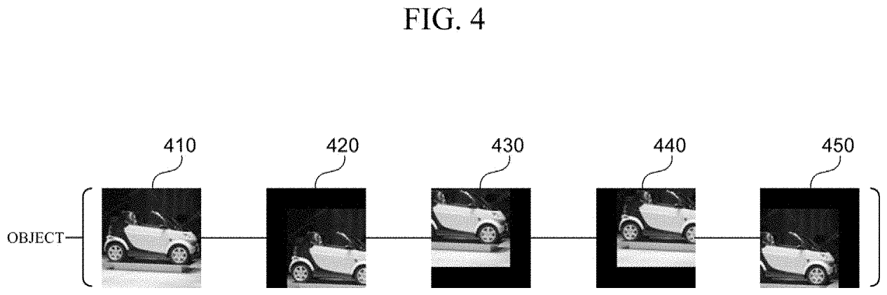

As another example, as shown in FIG. 4, the plurality of environments may be an environment in which the location of a camera photographing an object is different from the others. Referring to FIG. 4, the plurality of environments may be an environment in which an object is photographed from different positions using one camera or an object is photographed by a plurality of camera installed at different locations. Accordingly, a plurality of images 410, 420, 430, 440, 450 of an object may include images of the object photographed from different positions.

Meanwhile, although it is described in the above example that a plurality of environments may be an environment in which a plurality of light sources is installed or the locations of cameras photographing an object are different from each other, it is not necessarily limited thereto. Accordingly, the environments described above are only an example, and the environments of generating a plurality of images of an object may be diverse.

At step 220, the computing device 12 generates an integrated feature vector including a feature vector of each of the plurality of images.

At this point, the feature vector may be a vector including one or more feature values used for classifying an object as an element.

The integrated feature vector may be a vector generated by connecting the feature vector of each of the plurality of images.

Specifically, the computing device 12 may extract a feature vector of each of a plurality of images and generate an integrated feature vector by using the extracted feature vector of each of the plurality of images.

For example, the computing device 12 may extract a feature vector of each of a plurality of images by using a plurality of feature extraction models trained on the basis of a plurality of training images generated in one of the plurality of environments different from each other.

In an embodiment, the plurality of feature extraction models may be a convolution neural network (CNN) model. For example, the plurality of feature extraction models may include a convolution layer, a pooling layer, a fully connected layer and the like.

For example, it is assumed that there are a plurality of training images generated in an environment of brightness A and a plurality of training images generated in an environment of brightness B. The computing device 12 may generate a feature extraction model for the environment of brightness A and a feature extraction model for the environment of brightness B. Then, the computing device 12 may train the feature extraction model for the environment of brightness A by using the plurality of training images generated in an environment of brightness A, and train the feature extraction model for the environment of brightness B by using the plurality of training images generated in an environment of brightness B.

As another example, it is assumed that there are a plurality of training images generated by a photographing means positioned at location A and a plurality of training images generated by a photographing means positioned at location B. The computing device 12 may generate a feature extraction model for location A and a feature extraction model for location B. Then, the computing device 12 may train the feature extraction model for location A by using the plurality of training images generated by the photographing means positioned at location A, and train the feature extraction model for location B by using the plurality of training images generated by the photographing means positioned at location B.

In an embodiment, the plurality of feature extraction models may be independently trained. At this point, an initial parameter of each of the plurality of feature extraction models may be set independently.

For example, the computing device 12 may train the feature extraction model for the environment of brightness A by using the plurality of training images generated in an environment of brightness A, and independently, the computing device 12 may train the feature extraction model for the environment of brightness B by using the plurality of training images generated in an environment of brightness B. At this point, the initial parameter of each of the feature extraction model for the environment of brightness A and the feature extraction model for the environment of brightness B may be independent from each other.

As another example, the computing device 12 may train the feature extraction model for location A by using the plurality of training images generated by the photographing means positioned at location A, and independently, the computing device 12 may train the feature extraction model for location B using the plurality of training images generated by the photographing means positioned at location B. At this point, the initial parameter of each of the feature extraction model for location A and the feature extraction model for location B may be independent from each other.

Like this, since the plurality of feature extraction models is independently trained by using the initial parameters independent from each other, the computing device 12 may extract a feature vector expressing well the data about a plurality of images by using the plurality of feature extraction models.

In addition, unlike the example described above, the plurality of feature extraction models may be sequentially trained.

In an embodiment, the plurality of feature extraction models may be sequentially trained by using the parameter of a previously trained feature extraction model among the plurality of feature extraction models as initial parameter of a feature extraction model to be trained currently among the plurality of feature extraction models.

For example, the computing device 12 may train the feature extraction model for the environment of brightness B by using a plurality of training images generated in an environment of brightness B, after training the feature extraction model for the environment of brightness A by using a plurality of training images generated in an environment of brightness A. At this point, the computing device 12 may train the feature extraction model for the environment of brightness B by using a plurality of training images generated in an environment of brightness B, after determining the parameter of the feature extraction model trained by using a plurality of training images generated in an environment of brightness A as an initial parameter of the feature extraction model for the environment of brightness B.

As another example, the computing device 12 may train the feature extraction model for location B by using a plurality of training images generated by a photographing means positioned at location B, after training the feature extraction model for location A by using a plurality of training images generated by a photographing means positioned at location A. At this point, the computing device 12 may train the feature extraction model for location B by using a plurality of training images generated by the photographing means positioned at location B, after determining the parameter of the feature extraction model trained by using a plurality of training images generated by the photographing means positioned at location A as an initial parameter of the feature extraction model for location B.

Like this, as a plurality of feature extraction models are sequentially trained by using the parameter of a previously trained feature extraction model as an initial parameter, the computing device 12 may enhance the feature extraction performance of a plurality of feature extraction models although the plurality of feature extraction models is trained using a small amount of training images.

Meanwhile, although it is described in the above example that a plurality of feature extraction models is trained by using training images generated in a plurality of environments of different brightness or generated by photographing means positioned at different locations, it is not necessarily limited thereto. Accordingly, the plurality of feature extraction models may be trained by using various images generated in a plurality of environments in which the conditions of generating an image, such as luminance, the number of light sources, brightness of the light sources, location of a camera, angle of a camera, the number of cameras and the like, are different from each other.

Meanwhile, the computing device 12 may generate at least one among an average feature vector, a minimum feature vector, and a maximum feature vector on the basis of the feature vector of each of the plurality of images.

At this point, the average feature vector may include an average value of feature values at a same location in the feature vector of each of the plurality of images.

Specifically, the computing device 12 may generate an average feature vector by calculating an average value by the location of the feature values included in the feature vector of each of the plurality of images.

For example, a feature value included in an average feature vector may be expressed below as shown in equation 1.

$$Feature\_ avg [ i ] = \frac{{F}_{1} [ i ] + {F}_{2} [ i ] + {F}_{3} [ i ] + ⋯ + {F}_{N} [ i ]}{N} , i = 0 , 1 , 2 … \qquad [ Equation 1 ]$$

In equation 1, Feature_avg denotes a feature value included in an average feature vector, i denotes an index, and F denotes a feature vector of an image.

Accordingly, as the average feature vector is generated on the basis of the feature vector of each of the plurality of images, there is an effect in that the computing device 12 may remove the noises included in the plurality of images.

The minimum feature vector may include a feature value having a minimum value among feature values at the same location in the feature vector of each of the plurality of images.

Specifically, the computing device 12 may generate a minimum feature vector by extracting a feature value having a minimum value by the location of the feature values included in the feature vector of each of the plurality of images.

For example, a feature value included in a minimum feature vector may be expressed below as shown in equation 2.

Feature_min[i]=min(F₁[i],F₂[i],F₃[i], . . . ,F_{N}[i]),i=0,1,2 . . . [Equation 2]

In equation 2, Feature_min denotes a feature value included in a minimum feature vector.

Accordingly, as the minimum feature vector is generated on the basis of the feature vector of each of the plurality of images, the computing device 12 may accurately grasp the factors hindering classification of an object.

The maximum feature vector may include a feature value having a maximum value among feature values at the same locations in the feature vector of each of the plurality of images.

Specifically, the computing device 12 may generate a maximum feature vector by extracting a feature value having a maximum value by the location of the feature values included in the feature vector of each of the plurality of images.

For example, a feature value included in a maximum feature vector may be expressed below as shown in equation 2.

Feature_max[i]=max(F₁[i],F₂[i],F₃[i], . . . ,F_{N}[i]),i=0,1,2 . . . [Equation 3]

In equation 3, Feature_max denotes a feature value included in a maximum feature vector.

Accordingly, as the minimum feature vector is generated on the basis of the feature vectors of the plurality of images, the computing device 12 may accurately grasp important factors such as an edge, a corner, a contour and the like in classifying an object from a plurality of images.

Meanwhile, although it is described in the above example that the computing device 12 generates an average feature vector, a minimum feature vector, and a maximum feature vector on the basis of a feature vector of each of a plurality of images, it is not necessarily limited thereto.

For example, the computing device 12 may generate various forms of feature vectors based on a feature vector of each of a plurality of images, in addition to the average feature vector, the minimum feature vector, and the maximum feature vector generated on the basis of equations 1 to 3 described above. In this case, the computing device 12 may generate various forms of feature vectors by applying various equations, such as an equation other than the equations described above, to the feature vectors of the plurality of images. In addition to the equations described above, the computing device 12 may generate various forms of feature vectors by using various algorithms, such as changing the order of the feature values included in the feature vector of each of the plurality of images or merging the feature values, on the basis of a specific algorithm.

Meanwhile, the computing device 12 may generate an integrated feature vector including at least one among the average feature vector, the minimum feature vector and the maximum feature vector and the feature vector of each of the plurality of images.

For example, the integrated feature vector may be a vector generated by connecting at least one among the average feature vector, the minimum feature vector and the maximum feature vector and the feature vector of each of the plurality of images.

At this point, the order of connecting the feature vector of each of the plurality of images, the average feature vector, the minimum feature vector and the maximum feature vector in the integrated feature vector may be various according to embodiments.

Accordingly, as an integrated feature vector is generated on the basis of a plurality of images, the computing device 12 may classify an object by using all the images generated by photographing the object in the photographing environments different from each other.

Meanwhile, although it is described in the above example that the computing device 12 generates an integrated feature vector on the basis of an average feature vector, a minimum feature vector, a maximum feature vector, and a feature vector of each of a plurality of images, it is not necessarily limited thereto. For example, the computing device 12 may generate the integrated feature vector also considering various forms of feature vectors generated by applying various equations or various algorithms to the feature vector of each of the plurality of images as described above.

Meanwhile, the computing device 12 may classify the object on the basis of the integrated feature vector.

At this point, although the computing device 12 may classify the object by using, for example, a softmax function, it is not necessarily limited thereto, and the computing device 12 may classify the object by using various activation functions according to embodiments.

Specifically, the computing device 12 may determine a class corresponding to the object on the basis of the integrated feature vector. For example, the computing device 12 may calculate a probability that the object corresponds to a specific class among a plurality of classes on the basis of the integrated feature vector. At this point, the computing device 12 may determine a class having the highest probability among the plurality of classes as a class corresponding to the object.

The class indicates a type of an object included in an image, and various classes may exist depending on the category. For example, a species of an animal, such as a dog, a cat or the like, may be a class. In addition, according to another example, a type of defect, such as dust, a scratch, a foreign material or the like, also can be a class.

Meanwhile, although the method is described as being divided into a plurality of steps in the flowchart shown in FIG. 2, at least some of the steps may be performed in a different order or in combination and together with the other steps, omitted, divided into detailed steps, or performed in accompany with one or more steps not shown in the figure.

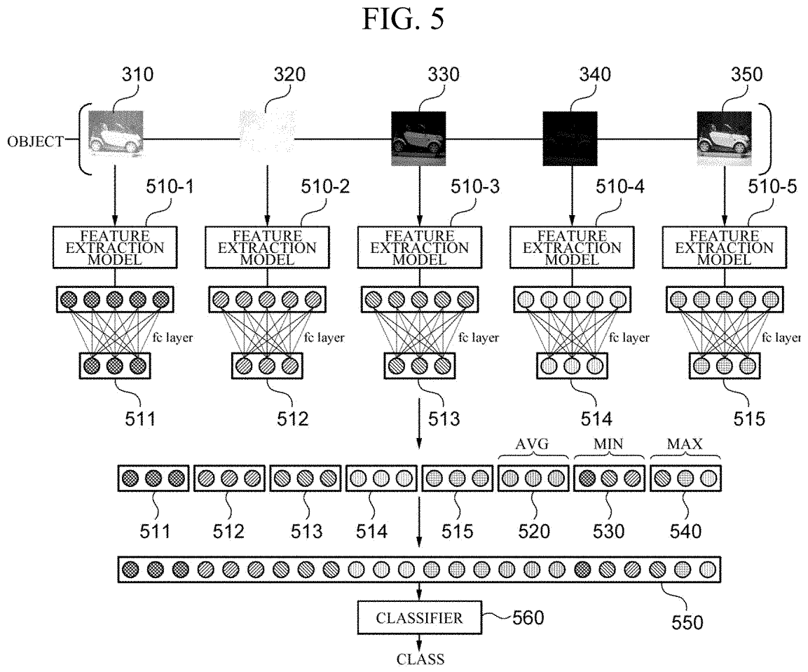

FIG. 5 is a view showing an example of classifying an object on the basis of an integrated feature vector according to an embodiment.

Referring to FIG. 5, a plurality of images 310, 320, 330, 340 and 350 of an object is inputted into the computing device 12.

Then, the computing device 12 may extract feature vectors 511, 512, 513, 514 and 515 of the plurality of images by using a plurality of feature extraction models 510-1, 510-2, 510-3, 510-4 and 510-5 trained on the basis of a plurality of training images generated in one of a plurality of environments different from each other.

Next, the computing device 12 may generate an average feature vector 520, a minimum feature vector 530, and a maximum feature vector 540 on the basis of the feature vectors 511, 512, 513, 514 and 515 of the plurality of images.

Next, the computing device 12 may generate an integrated feature vector 550 by sequentially connecting the feature vectors 511, 512, 513, 514 and 515 of the plurality of images, the average feature vector 520, the minimum feature vector 530, and the maximum feature vector 540.

Next, the computing device 12 may classify the object on the basis of the integrated feature vector 550 through a classifier 560 using, for example, a softmax function.

Next, the computing device 12 may output a classification result of the object using the classifier 560.

Meanwhile, although it is described in FIG. 5 that an object is classified by using a plurality of images of the object generated in a plurality of environments each having different brightness, this is only an example, and it can be applied to all of the plurality of images generated by photographing the object in various photographing environments. Accordingly, the computing device 12 may classify an object by receiving all the images of the object, such as a plurality of images generated by photographing the object from different positions, in addition to a plurality of images of the object generated in a plurality of photographing environments each having different brightness.

Accordingly, according to the disclosed embodiments, although the feature vectors of the images included in the integrated feature vector are data extracted from one object, they may have feature values different form each other according to the environments in which the images are generated. Accordingly, the feature vectors of the images shown in different environments can be clearly distinguished by using the integrated feature vector.

In addition, the pattern of a feature vector of each image can be confirmed through the average feature vector, the minimum feature vector, and the maximum feature vector included in the integrated feature vector. Specifically, it is possible to confirm a noise data or a data hindering the classification work and accurately grasp an image, from which a data having a strong feature value is extracted, through the integrated feature vector.

Unlike this, the conventional technique performs training by receiving a plurality of images of an object one by one. Accordingly, when images generated in a very dark or bright environment are inputted, the conventional technique extracts feature vectors having the same pattern from the images regardless of a class assigned to each image.

Accordingly, the conventional technique has an inconvenience in that an image generated in an environment which is difficult to output a classification result should be removed in advance, and has a problem of outputting an incorrect classification result of the images generated in a plurality of environments for the same object.

As a result, according to the disclosed embodiments, as an integrated feature vector of an object is generated and a classification result of the object is outputted, a pattern of a feature vector of each image of the object generated in a different environment can be correctly grasped, and the accuracy of the classification result of the object can be enhanced. In addition, since a work of preprocessing an image for training is not performed, the time and cost consumed for training a model can be reduced.

Meanwhile, the embodiments of the present invention may include programs for performing the methods described in this specification on a computer and computer-readable recording media including the programs. The computer-readable recording media may store program commands, local data files, local data structures and the like is independently or in combination. The media may be specially designed and configured for the present invention or may be commonly used in the field of computer software. Examples of the computer-readable recording media include magnetic media such as a hard disk, a floppy disk and a magnetic tape, optical recording media such as CD-ROM and DVD, and hardware devices specially configured to store and execute program commands, such as ROM, RAM, flash memory and the like. An example of the program may include a high-level language code that can be executed by a computer using an interpreter or the like, as well as a machine code generated by a compiler.

The technical features have been described above focusing on embodiments. However, the disclosed embodiments should be considered from the descriptive viewpoint, not the restrictive viewpoint, and the scope of the present invention is defined by the claims, not by the descriptions described above, and all the differences within the equivalent scope should be interpreted as being included in the scope of the present invention.

1: A method of generating an integrated feature vector performed in a computing device comprising one or more processors and a memory for storing one or more programs executed by the one or more processors, the method comprising:
receiving a plurality of images of an object; and
generating the integrated feature vector including a feature vector of each of the plurality of images,
wherein the plurality of images is generated in a plurality of environments different from each other.

2: The method of claim 1, wherein the plurality of environments comprise at least one or more among an environment in which a plurality of light sources is installed and an environment in which the object is photographed from a plurality of positions.

3: The method of claim 1, wherein the generating comprises:
extracting the feature vector of each of the plurality of images;
generating at least one among an average feature vector, a minimum feature vector and a maximum feature vector on the basis of the feature vector of each of the plurality of images; and
generating the integrated feature vector including at least one among the average feature vector, the minimum feature vector and the maximum feature vector, and the feature vector of each of the plurality of images.

4: The method of claim 3, wherein the extracting comprises extracting the feature vector of each of the plurality of images by using a plurality of feature extraction models trained on the basis of a plurality of training images generated in one of the plurality of environments.

5: The method of claim 4, wherein the plurality of feature extraction models are independently trained by using initial parameters independent from each other.

6: The method of claim 4, wherein the plurality of feature extraction models are sequentially trained by using a parameter of a previously trained feature extraction model among the plurality of feature extraction models as an initial parameter of a feature extraction model to be trained currently among the plurality of feature extraction models.

7: The method of claim 3, wherein the average feature vector comprises an average value of feature values at a same location in the feature vector of each of the plurality of images.

8: The method of claim 3, wherein the minimum feature vector comprises a feature value having a minimum value among feature values at a same location in the feature vector of each of the plurality of images.

9: The method of claim 3, wherein the maximum feature vector comprises a feature value having a maximum value among feature values at a same location in the feature vector of each of the plurality of images.

10: The method of claim 1, further comprising classifying the object on the basis of the integrated feature vector.

11: An apparatus for generating an integrated feature vector, comprising one or more processors, a memory, and one or more programs, wherein the one or more programs are stored in the memory and configured to be executed by the one or more processors and comprise commands for executing:
receiving a plurality of images of an object; and
generating the integrated feature vector including a feature vector of each of the plurality of images,
wherein the plurality of images is generated in a plurality of environments different from each other.

12: The apparatus of claim 11, wherein the plurality of environments comprise at least one or more among an environment in which a plurality of light sources is installed and an environment in which the object is photographed from a plurality of positions.

13: The apparatus of claim 11, wherein the generating comprises:
extracting the feature vector of each of the plurality of images;
generating at least one among an average feature vector, a minimum feature vector and a maximum feature vector on the basis of the feature vector of each of the plurality of images; and
generating the integrated feature vector including at least one among the average feature vector, the minimum feature vector and the maximum feature vector, and the feature vector of each of the plurality of images.

14: The apparatus of claim 13, wherein the extracting comprises extracting the feature vectors of the plurality of images by using a plurality of feature extraction models trained on the basis of a plurality of training images generated in one of the plurality of environments.

15: The apparatus of claim 14, wherein the plurality of feature extraction models are independently trained by using initial parameters independent from each other.

16: The apparatus of claim 14, wherein the plurality of feature extraction models are sequentially trained by using a parameter of a previously trained feature extraction model among the plurality of feature extraction models as an initial parameter of a feature extraction model to be trained currently among the plurality of feature extraction models.

17: The apparatus of claim 13, wherein the average feature vector comprises an average value of feature values at a same location in the feature vector of each of the plurality of images.

18: The apparatus of claim 13, wherein the minimum feature vector comprises a feature value having a minimum value among feature values at a same location in the feature vector of each of the plurality of images.

19: The apparatus of claim 13, wherein the maximum feature vector comprises a feature value having a maximum value among feature values at a same location in the feature vector of each of the plurality of images.

20: The apparatus of claim 11, wherein the one or more programs further comprise commands for executing classifying the object on the basis of the integrated feature vector.
